(19) United States
(12) Patent Application Publication
(10) Pub. No.: US 2008/0275913 A1
(43) Pub. Date: Nov. 6, 2008

(54) Dynamic assignment of statements for selected exams using clinical concepts

(76) Inventors: Paul van Arragon, Waterloo (CA); John DeLong, Millbank (CA); Cleon Hill Wood-Salomon, Jacobs (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 11/797,154

(22) Filed: May 1, 2007

(51) Int. Cl. G06F 17/30

(52) U.S. Cl. 707/104.1; 707/E17.009

(57) ABSTRACT

A system and method for generating statements for use by a user in collecting clinically relevant information about a patient for a selected examination type. The system comprises a storage including a plurality of statements having statement concepts assigned to each of the plurality of statements, the statement concepts being descriptors for defining each of the plurality of statements. The system comprises a receipt module configured for receiving a request having at least one parameter including an exam concept associated with the selected exam type for defining a characteristic of the selected exam type. The system comprises a matching module configured for comparing the exam concept to the statement concepts assigned to each of the plurality of statements, the comparison for selecting matching statements from the plurality of statements having the exam concept, the comparison resulting in a statement set containing the matched statements. The system comprises a generation module configured for generating a statement form including the statement set, the statement form for use by the user in collecting the clinically relevant information about the patient.

### FIELD OF THE INVENTION

This invention relates to the generation of forms for the collection of patient specific clinical information.

### BACKGROUND OF THE INVENTION

In today's clinical environment, the consultation of patients and the required examinations based on those consultations requires the collection of pertinent patient information that is clinically relevant or otherwise specific to the patient. The problem is that there are thousands of possibilities for the content of statements on a statement form, based on medical practitioner characteristics, patient characteristics, among others. With so many possibilities, it can be difficult for the medical practitioner to have statement forms that are relevant to the patient consultation at hand. For example, statement forms with many extraneous statements can inhibit the collection of patient information pertaining to relevant statements.

Further, unless the patient information collected for selected statements is of high quality, reflecting well the actual clinical condition of the patient, decision support as well as further treatment of the patient may not be efficient. For example, if the collected patient information is too vague or lacking, decision support has no basis to assist the medical practitioner in treatment because the clinical condition of the patient cannot be determined sufficiently. Further, if the collected patient information includes accurate information, but information that isn't of primary importance, decision support could be misled into pursuing an irrelevant path of patient inquiry and/or treatment.

In terms of deployment of generation systems for static statement forms at a clinical site, one needs a way to take a configuration of the static content of the statement forms and to upload it to the clinical site's database. Each customer (i.e. clinical site) has their own way of defining statements based on context, thus requiring a multitude of standard content statement forms. For example, if it is specified by a particular site that they tend to order more radiology exams for paediatrics or adults, males or females, and so on, then based on the particulars of the site the configuration of the static content of the statement forms must be created and provided particular to that site. Unfortunately, the method of statically defining the content of multiple statement forms has the obvious drawback that there is configuration work of the statement forms needed up front specifically for each customer.

A further issue with current form generation systems is ongoing maintenance of the statement forms and other related content, which requires the merging any changes with changes that each customer has already made to their set of static statement forms. Accordingly, current form generation systems that use a plurality of distinct statement forms for each desired exam are difficult systems to maintain because they cannot capture relevant patterns.

A further concern for static content of statement forms is the quality of the statement information on examination orders. For example, needed is an interactive solution for improving the information content on the orders for other medical practitioners (e.g. radiologists) by prompting the primary physician, for example, for patient information that they might not otherwise think to collect. Desired is a form generation system that can be used to improve the likelihood that the patient information on the examination order is more complete and relevant for the medical practitioner conducting the requested examination. For example, it is noted that the needed statement form content can vary for specialists. For example, the statements presented to a primary care physician, while ordering a CT Head for a patient, could be significantly different than the statements presented to a neurologist, since the neurologist could provide more detail about what they are looking for.

### SUMMARY OF THE INVENTION

It is an object of the present invention to provide a statement form generation system to obviate or mitigate at least some of the above-presented disadvantages.

An issue with current form generation systems is ongoing maintenance of the statement forms and other related content, which requires the merging any changes with changes that each customer has already made to their set of static statement forms. Accordingly, current form generation systems that use a plurality of distinct statement forms for each desired exam are difficult systems to maintain because they cannot capture relevant patterns. Contrary to current systems and methods there is provided a system and method for generating statements for use by a user in collecting clinically relevant information about a patient for a selected examination type. The system comprises a storage including a plurality of statements having statement concepts assigned to each of the plurality of statements, the statement concepts being descriptors for defining each of the plurality of statements. The system comprises a receipt module configured for receiving a request having at least one parameter including an exam concept associated with the selected exam type for defining a characteristic of the selected exam type. The system comprises a matching module configured for comparing the exam concept to the statement concepts assigned to each of the plurality of statements, the comparison for selecting matching statements from the plurality of statements having the exam concept, the comparison resulting in a statement set containing the matched statements. The system comprises a generation module configured for generating a statement form including the statement set, the statement form for use by the user in collecting the clinically relevant information about the patient.

One aspect provided is a system for generating statements for use by a user in collecting clinically relevant information about a patient for a selected examination type, the system comprising: a storage including a plurality of statements having statement concepts assigned to each of the plurality of statements, the statement concepts being descriptors for defining each of the plurality of statements; a receipt module configured for receiving a request having at least one parameter including an exam concept associated with the selected exam type for defining a characteristic of the selected exam type; a matching module configured for comparing the exam concept to the statement concepts assigned to each of the plurality of statements, the comparison for selecting matching statements from the plurality of statements having the exam concept, the comparison resulting in a statement set containing the matched statements; and a generation module configured for generating a statement form including the statement set, the statement form for use by the user in collecting the clinically relevant information about the patient.

A further aspect provided is a method for generating statements for use by a user in collecting clinically relevant information about a patient for a selected examination type, the method comprising the acts of: assigning statement concepts storage to each of a plurality of statements, the statement concepts being descriptors for defining each of the plurality of statements; receiving a request having at least one parameter including an exam concept associated with the selected exam type for defining a characteristic of the selected exam type; comparing the exam concept to the statement concepts assigned to each of the plurality of statements, the comparison for selecting matching statements from the plurality of statements having the exam concept, the comparison resulting in a statement set containing the matched statements; and generating a statement form including the statement set, the statement form for use by the user in collecting the clinically relevant information about the patient.

A still further aspect provided is a computer program product for configuring a computer to generate statements for use by a user in collecting clinically relevant information about a patient for a selected examination type, the computer program product comprising: a computer readable medium; a storage module stored on the computer readable medium and including a plurality of statements having statement concepts assigned to each of the plurality of statements, the statement concepts being descriptors for defining each of the plurality of statements; a receipt module stored on the computer readable medium and configured for receiving a request having at least one parameter including an exam concept associated with the selected exam type for defining a characteristic of the selected exam type; a matching module coupled to the receipt module and configured for comparing the exam concept to the statement concepts assigned to each of the plurality of statements, the comparison for selecting matching statements from the plurality of statements having the exam concept, the comparison resulting in a statement set containing the matched statements; and a generation module coupled to the matching module and configured for generating a statement form including the statement set, the statement form for use by the user in collecting the clinically relevant information about the patient.

### BRIEF DESCRIPTION OF THE DRAWINGS

Exemplary embodiments of the invention will now be described in conjunction with the following drawings, by way of example only, in which:

FIG. 1 is a block diagram of components of a statement form environment;

FIG. 2 is a block diagram of an example computing device network of the statement form environment of FIG. 1;

FIG. 3 is an example computing device of the network of FIG. 2;

FIG. 4 is a block diagram of an example tool of the environment of FIG. 1;

FIG. 5 shows an example hierarchy for representing the concepts and statements of FIG. 1;

FIG. 6a is an example structure of the subjects of FIG. 1;

FIG. 6b is an example exam type structure of FIG. 6a;

FIG. 6c is an example patient structure of FIG. 6a;

FIG. 6d is an example medical practitioner structure of FIG. 6a;

FIG. 6e is an example exam request of FIG. 1;

FIG. 6f is an example statement structure of FIG. 6a;

FIG. 7 is an example operation of the tool of FIG. 1;

FIG. 8 is a further embodiment of the exam request of FIG. 6e;

FIG. 9 is a further embodiment of the exam request of FIG. 8;

FIG. 10 shows the matched statements to the exam requests of FIG. 9;

FIG. 11 is a further embodiment of the statement structure of FIG. 6f;

FIG. 12 is a further embodiment of the statement structure of FIG. 6f;

FIG. 13 is a further embodiment of the statement structure of FIG. 6f;

FIG. 14 is a further embodiment of the statement structure of FIG. 6f;

FIG. 15 shows one embodiment of an implementation model of the environment of FIG. 1;

FIG. 16 shows a further embodiment of the implementation model of the environment of FIG. 1; and

FIG. 17 shows an administration model of the environment of FIG. 1.

### DETAILED DESCRIPTION OF THE PREFERRED EMBODIMENT(S)

### Statement Form Environment 1

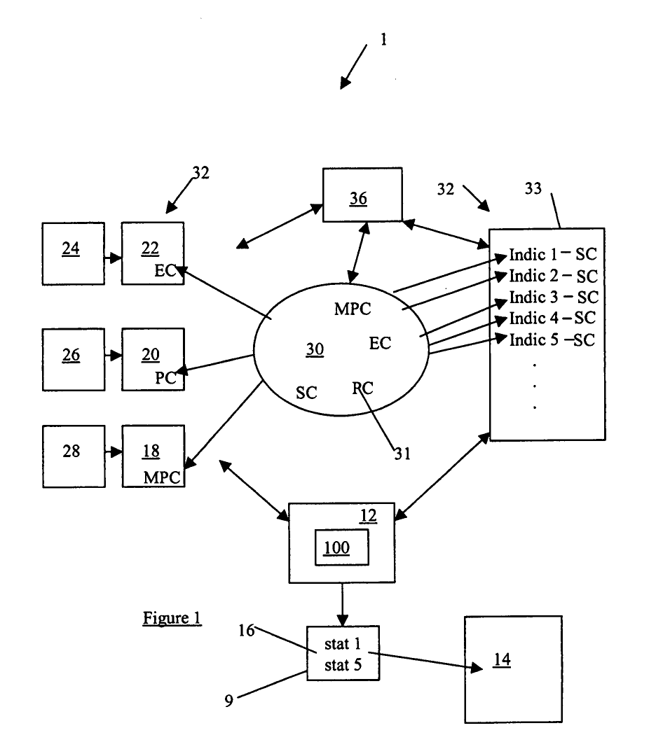

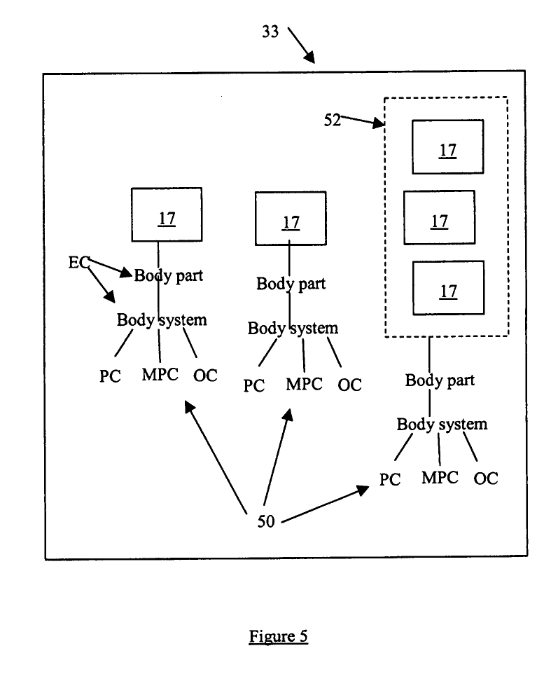

Referring to FIG. 1, a generation tool 12 is configured for generating a statement form 9 (or series of forms 9), for example suitable for inclusion with an examination request 14. The statement form 9 has a set of statements 16 that includes a group of statements 17 (see FIG. 5) such as questions or other desired information including a list of clinical terms that can be used to describe the clinical reasons for placing an examination order (e.g. defined as part of the examination request 14—for radiology) for aiding a medical practitioner 18 (e.g. user such as doctor, medical specialist, nurse, clinician, radiologist, etc.) in the examination/treatment of a selected patient 20. The generated statement form 9 is based on an examination type 22 selected from an examination catalogue 24 having a plurality of different ones of the initial examination types 22. Further, it is recognised that the medical practitioner 18 can select the patient 20 from a registered patient list 26. Further, it is recognised that the medical practitioner 18 can be part of a list 28 of registered medical practitioners 18. Accordingly, the set of statements 16 is selected from a plurality of statement 17 possibilities that are deemed by the generation tool 12 as applicable to the desired exam request 14, as further described below.

An example workflow of the system 1 is where a physician (e.g. medical practitioner 18) begins by logging on to their computing device 101. Physician 18 related information is thereby placed in context, i.e. made available to the system 1 through association with the registered physician 18. After seeing the patient 20, the physician 18 may decide to place a radiology order (e.g. the exam request 14). The next step is to select the patient 20 from the patient list 26, for example, thereby putting the patient related information in context, i.e. made available to the system 1 through association with the registered patient 20. Next, the physician 18 will select a particular exam type 22 (e.g. such as an X-ray specifying what body part they want to X-ray). Based on the configuration of the system 1, the tool 12 will then generate the statement form 9 for use by the physician during examination of the patient 20. This is the point at which practitioner-supplied information is obtained in association with each of the statements 17 on the statement form 9. This obtained information can be entered electronically with respect to each of the statements 17 and/or can be supplied as hand-written information on a printed hard copy of the statement form 9. The patient information collected from the patient 20 for each of the statements 17 on the statement form 9 can be facilitated by techniques such as but not limited to: text or other values entered into a data field adjacent to the statement 17 (e.g. location of pain); selection of a predefined answer to the statement from a list of provided answers (e.g. check boxes, drop down menu selections, etc.) adjacent to the statement 17; and/or filling out a series of data fields on a supplemental form associated with the statement.

Next, the medical practitioner includes in the exam request 14 the obtained information associated with the statements 17 of the statement set 16. It is recognised that the obtained information associated with the statements 17 can include relevant patient information needed to facilitate subsequent treatment of the patient 20 and/or for facilitating provided feedback concerning usefulness of the chosen exam type 22, or suggestion of an alternative exam type 22. There may also be a need for further questioning about reasons for the exam type 22. For example, when ordering a radiology exam, a physician 18 specifies a number of items pertaining to the order/exam request 14 such as but not limited to: the exam specifics, such as a Chest X-ray (e.g. exam type 22); patient 20 identification; and reason(s) for the exam (also known as statements 17 with obtained patient specific information).

Referring again to FIG. 1, a set of clinical concepts 30 is provided, such that some of the individual concept(s) 31 of the set 30 are assigned to each of statements 17, the exam types 22 of the catalogue 24, each of the registered patients 20, and to each of the registered medical practitioners 18, as a whole referred to generically as subjects 32. It is recognised that if a particular subject 32 is not contained in one of the subject 32 lists (e.g. patient list 26), then a series of concepts 31 from the set 30 can be dynamically assigned as input to the tool 12 by the medical practitioner 18 and/or by a third party (not shown—e.g. receptionist), as desired. The concepts 31 associated with the subjects 32 facilitate generation (by the tool 12) of the set of statements 16 (from the statement list 33), which are appropriate for the particular medical practitioner 18 placing the exam request 14 for the particular patient 20.

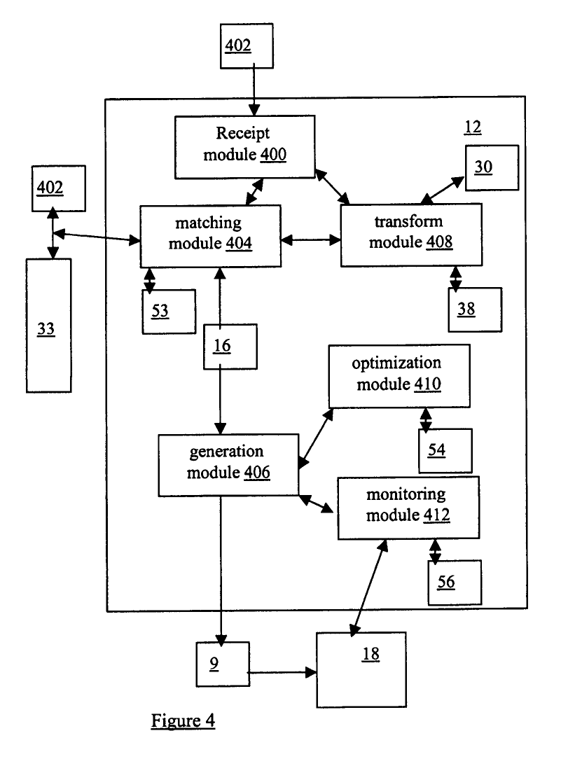

Referring again to FIG. 1, individual concepts 31 is/are assigned by an administrator 36 to each of the subjects 32, during setup of the system 1. In particular, concepts are assigned to each exam type 22, each patient 20, each medical practitioner 18, and each statement 16, as further described below. The tool 12 has a matching module 404 (see FIG. 4) for matching individual statements 17 to the selected examination type 22, in view of the selected patient 20 and practitioner 18, based on the commonality of assigned statements 17 there-between, as further described below. It is recognised that the concepts 31 assigned to the statements 17 facilitate for dissemination by the system 1 of the meaning/relevance of the statements 17 and the patient specific information obtained with respect to each of the statements 17 present on the statement form 9.

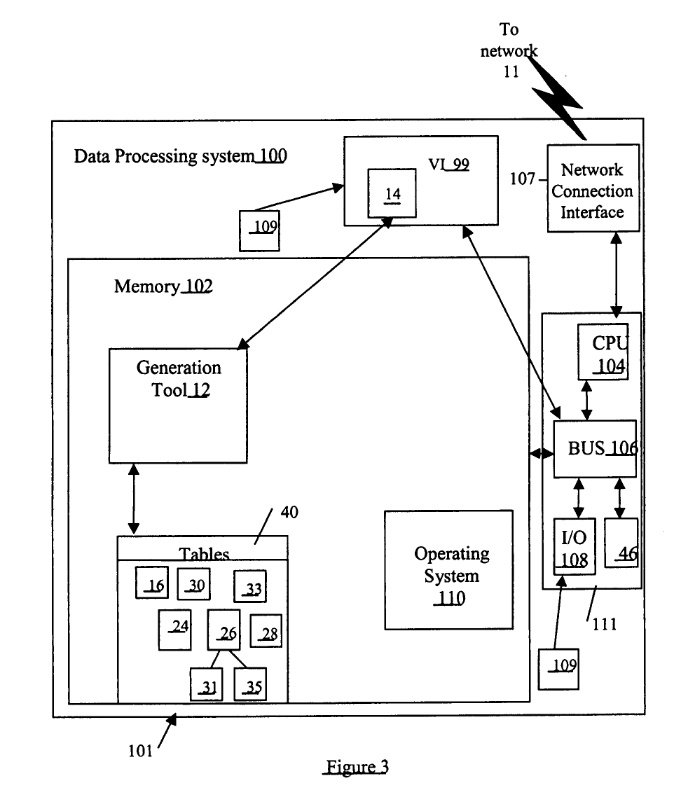

Referring again to FIG. 1, concept(s) 31 are assigned by the administrator 36 (as well as potentially by individuals such at the medical practitioner 18 for the patient 20, for example) to the various subjects 32 of the system 1. The concepts 31 for each of the statements 17 (e.g. statement concepts SC) can be selected from; examination related concepts EC, patient related concepts PC, and medical practitioner related concepts MPC, for example, from the concept set 30. Accordingly, it is the inspection and processing of these concepts 17 that the matching module 404 uses in matching selected statements 17 to the selected examination type 22 in order to generate the statement form 9 for use by the medical practitioner 18 in examination of the patient 20. The statement form 9 can be displayed on a practitioner version of an electronic device 101 used by the medical practitioner 18, as further described below. Further, it is recognised that the tool 12 can also be executed on a statement generator version of the electronic device 101 coupled via the network 11 to the practitioner electronic device 101. Further, it is recognised that the statements 17 of the subjects 32 are used as input by the tool 12 for use in generation of the statement form 9, and can be for example obtained from a memory 102 (see FIG. 3).

It is recognised that the various computing devices 101 of the environment 1 can communicate with one another via one or more networks 11, such as but not limited to intranets and extranets (e.g. the Internet) as desired.

### Subjects 32

In generation of the examination 14 (such as an examination request or order or actual conducted examination), subjects 32 correlated by the tool 12 for determination of the configured content for inclusion in the generated statement form 9 can include subjects 32 such as but not limited to: exam types 22; patients 20; medical practitioners 18; and/or statements 17. It is recognised that selected ones of the predefined concepts 31 of the concept set 30 are assigned to the subjects 32, in order to facilitate generation of the statement forms 9 as further described below. The concepts 31 for each of the subjects 32 can be selected from; examination related concepts EC, patient related concepts PC, and medical practitioner related concepts MPC, for example.

### Exam Types 22

Referring again to FIG. 1, exam types 22 are categorized in the catalogue 24 based on a predefined minimum set of diagnostic order information. This diagnostic order information can include exam concepts EC such as but not limited to: modality type (e.g. CT, X-ray, MRI, etc.); procedure type and/or modifiers; body system; and/or body part/region.

The exam catalogue 24 can provide a menu of exam types 22 from which the medical practitioner 18 can choose. For each exam type 22, specified are the exam attributes modality and/or the body part by using the concepts EC, because this information can be used to determine what options will be on the statement form, as further described below.

For demonstrable example of the use of statements EC is where different radiology sites (e.g. different hospitals) will offer different sets of exams. For each exam from each site, the exam attributes are defined as tailored for the needs of the particular radiology site. In this case, this process of assigning attributes (e.g. statements EC) to exams types 22 can be done by using a single comprehensive exam catalogue 24 up front, and then simply match the exam types 22 of new sites to exam types 22 in this exam catalogue 24.

For example, the adapted use of codes as ECs, such as CPT4 (Current Procedural Terminology, 4th Edition) codes, can be useful here. For example, if our catalogue 24 assigns CPT4's to each exam 22, and each new site does as well, we can match the CPT4's, and thereby identify the exams 22 from the site with exams 22 in the catalogue 24. Accordingly, all exams 22 that may be chosen from a menu of the catalogue 24 have the exam attributes applied to the exams 22.

### Patients 20

Referring again to FIG. 1, patients 20 are listed in the patient list 26 based on a predefined set of patient information. This patient information can include patient concepts PC such as but not limited to: patient age; patient sex; and/or other patient characterizing information (e.g. health condition).

In terms of sex, in medicine one generally has to be aware that not all people fit neatly into one category or the other. And furthermore, the sex is not always known, such as when dealing with a neonate. Nevertheless, we can take the strategy that we specify male or female, and if the actual sex is unknown or other, we can simply use the union of the statements for both male and female.

In terms of Age, this can be specified to great specificity, since some statements 17 are only useful for neonates, and others only for geriatrics. On the other hand, one can take a simpler approach and distinguish age at a much lower granularity. For example, the key distinction seems to be between pediatric age (birth to about 16 years) and adult age (greater than 16 years), however other age granularities can be used as desired, either numeric or descriptive (e.g. newborn, preschool, pre-teen, teenager, adult, middle age, etc).

In terms of other Patient Health Factors, several factors may be relevant if they are available, such as pregnancy status and whether menopause has been reached. These factors change over time, which can make them more difficult to use, but they provide for the tailoring of the statement 17 form as well.

### Medical Practitioners 18

Each medical practitioner 18 in the system 1 will have various kinds of information (e.g. concepts MPC) associated with them. We simply need to know whether each user is a physician, and if so, whether they are a specialist of any kind, or a general primary care physician. This sort of information can be entered into the medical practitioner 18 profile when the medical practitioner 18 is first added (or otherwise updated) to the system 1, and accessed whenever needed. These medical practitioner 18 concepts MPC can be such as but not limited to: physician; nurse; technologist (e.g. radiologist); physician sub-specialty; and/or physician type (e.g. resident, student, other).

### Statement List 33

Statements 17 are predefined and are included in the statement list 33, from which the predefined statements 17 are selected for inclusion in the statement form 9 based on their assigned concepts 31. Accordingly, the statement catalogue/list 33 consists of all of the statements 17 (e.g. questions on symptoms, diseases, and other patient info useful in facilitating subsequent patient 20 treatment) that are important enough to put on the generated statement form 9 associated with the exam type 22, as appropriate for inclusion in the exam request 14. The statements 17 can be considered reasons for doing the examination as requested by the medical practitioner 18.

It is recognized that the statements 17 (e.g. indications) can be any piece of information that is clinically relevant to the treatment or testing (e.g. exam 14) being considered for the patient 20. We can say that a diagnostic test is “indicated” if the patient information collected with respect to the statements/indications 17 make it appropriate that the test be done under the circumstances. Accordingly, each of the statements 17 can be a question, answer to a question, topic, sentence, phrase, circumstance, menu selection (or other form 9 content, as desired) presented on the form 9. The statements 17: point to or show the cause, pathology, treatment or issue of an attack of disease; that which point out; and/or that which serve as a guide or warning. The statements 17 can be configured on the forms 9 so as to facilitate the collection of clinical information pertaining to one or more potential diagnostic procedures applicable to the patient 20.

Further, it is recognized that the statements 17 can be given in terms of the signs or symptoms of the patient 20. The physician 18 can observe the signs, such as that the patient 20 has a cough. Symptoms can be subjectively perceived, such as pain, or a change in mental state. Statements 17 can also refer to patient history or even family history. For example, it may be useful to know that the patient 20 is known to have a tumor, or that her mother had a type of breast cancer that could be inheritable. The history of previous testing that has been done on the patient 20 is also a relevant statement 17. Statements 17 can also refer to diseases that the physician 18 suspects or desires to rule out. Even if we don't know why the physician 18 suspects a particular disease or syndrome, knowing that they do is relevant.

Many statements 17 can be further defined by giving detail about various patient 20 attributes. For example, the statement 17 on the forms 9 about a cough could have the content of: a duration—how long has the patient been coughing?; severity—how violently do they cough?; productivity—do they cough anything up or not?; time of day—is it restricted to night time, perhaps?; and instigation—perhaps they cough only when indoors, or after a deep breath.

The forms 9 can have specific statements 17 in some circumstances. First of all, it can be useful to use the forms 9 because the forms 9 are a way to focus the user's consideration of the relevant statements 17 (and clinically relevant information collected with respect thereto) that will be useful in determining if the exam 14 is appropriate for the patient 20. The forms 9 (and clinically relevant information collected with respect to the included statements 17) can also be useful for the radiologist to know what to look for when the exam 14 is done.

It is also recognized that if the forms 9 contain statements 17 that could not possibly apply to the medical circumstances/conditions of the patient 20, the forms 9 add noise, and make it harder to maximize the efficiency of the clinically relevant information collected. For example, if the patient 20 is a baby boy with a head injury, we should not present the user with the possibility of selecting (on the forms 9) the statement 17 “premature menopause”. In this case, this statement 17 cannot exist for the patient 20 for a number of reasons: menopause is a female condition; it cannot exist before a certain age, however premature; and it is not relevant to a head problem. Accordingly, the content of the statements 17 on the forms 9 are customized in view of the parameters 402 (see FIG. 4) used in generation of the forms 9.

For example, it is recognised that not every possible symptom and disease needs to be included in the statement form 9, but just those statements 17 that we need to be structured for providing desired patient information to be collected with respect to the selected exam type 22, patient 20 character, and/or medical practitioner 18 character. Structured are those statements 17 that can be most likely to benefit from decision support.

The statement list 33 is a large list of medical terms that could be part of a reason for a radiology exam (e.g. a selected exam type 22). There may be several hundred, or even thousands of different statements 17. Statements 17 come in different categories, such as but not limited to: Sx (Signs and Symptoms); Hx (History); Ddx (Differential Diagnosis); and other reasons, such as a pre-operative study, or to stage and restage cancer—for example. Some of the statements 17 can have additional structure to give details about some aspect of the patient 20. For example, an statement 17 like “pain” may also provide structure on the generated statement form 9 to allow the medical practitioner 18 to specify the duration and location of the pain, as communicated by the patient 20 or otherwise identified/surmised by the medical practitioner 18.

As with the other subjects 32, each of the statements 17 has concepts SC assigned, in order to assist the tool 12 in selection of particular matched statements 17 from the list 33 for inclusion in the statement form 9. As further described below, the clinical concepts 31 are used as attribute values of the above described subjects 32.

It is recognised that the statement list 33 can be modified for the addition/deletion/modification of included statements 17. The statement 17 definitions (for example excluding the associated concepts 31) can come from the following sources, such as but not limited to:

1) orders that were created by allowing the user to enter free text statements 17 can be mined to find commonly-used statements;

2) ordering physicians and radiologists can be canvassed as they know by experience what statements 17 they tend to use or see, this canvassing can be done by the service tool 814 (see FIG. 17) in response to user feedback for generated statement forms 9 and/or exam requests 14;

3) published decision support guidelines are useful sources of statements because the guidelines define clinical conditions under which clinical advice can be provided. These clinical conditions correspond to a set of statements; and

4) other published medical literature can be a source.

Referring again to FIG. 7, once a useful statement list 33 is created, the list can be used in the dynamic environment 1. By auditing and data mining the usage of the statement list 33 through the service tool 814, the environment 1 can learn which statements 17 were used frequently, which were not, and which statements 17 were missing. The latter can be determined if the users are allowed to type in free text when the statement 17 they want is not available in the generated statement form 9. The service tool 500 can also be used to learn from direct feedback from users who complain about the lack of certain statements 17 that they would otherwise use. This information feeds back into the statement list 33, leading to changes that make the statement list 33 become more optimized over time, as further described below.

### Concept Hierarchy 50

In one embodiment, referring to FIG. 5, the concepts 31 in the statement list 33 can be assigned to the included statements 17 based on a concept hierarchy 50. For example, the highest-level factors of the hierarchy 50 can be the body part and body system of each statement, e.g. exam concepts EC. This approach can facilitate the assignment of concepts 31 to the statements 17 (or groups of statements 52) by dealing with the body part and body system separately from the other concepts (e.g. patient concepts PC, medical practitioner concepts MPC, and other concepts OC). The first step is to define the statements 17 as if body part and body system are all that matters.

For example, one 17 and/or groups 52 of statements can be labelled “Head” (e.g. assigned the exam concept EC=“Head”). This superset of statements 17 can be used for any body system as long as the body part is “Head”. The system 1 can now assign the body part and body system concepts EC to each statement 17 simply by selecting which statements 17 should be included in the superset of head statements 17. Subsequently, each of the head statements 17 is further defined in a flexible manner with respect to the remaining concepts (e.g. PC, MPC, OC). That is, by choosing the body part and body system, we haven't fully defined the statements 17 completely, but have merely defined a superset of all statements 17 relevant to the body part and body systems selected. To complete the task, we need to assign the remaining concepts, such as patient sex and age to each of the statements 17 in the statement superset.

Further, the way that superset statements 17 are connected to body part and system may be further defined using the concept 31 of “Procedure” in the hierarchy 50, which can be used to distinguish some exams types 22 from each other that are otherwise indistinguishable in terms of the concepts introduced so for. As an example, X-ray Chest PA/Lat is a different exam from X-ray Portable Chest, but the two exams share the same modality, body part, and body systems. Accordingly, another example of the concept hierarchy 50 can be exam modality followed by body part/region followed by procedure followed by body systems followed by the remaining concepts 31.

It is recognised that assignment of concepts 31 to each of the statements 17 could select the clinical concepts 31 as statement 17 per statement 17. That is, one would look at each statement 17 one at a time and assign all of the concepts 31 to it. Instead, the service tool 500 can be envisioned that allows the set up all of the data in the memory 102 (see FIG. 1) so that these forms 9 can be generated. One set-up methodology is the hierarchy 50, providing statements 17 grouped by body part. That way, one can get a sense in advance of what is available on each form 9.

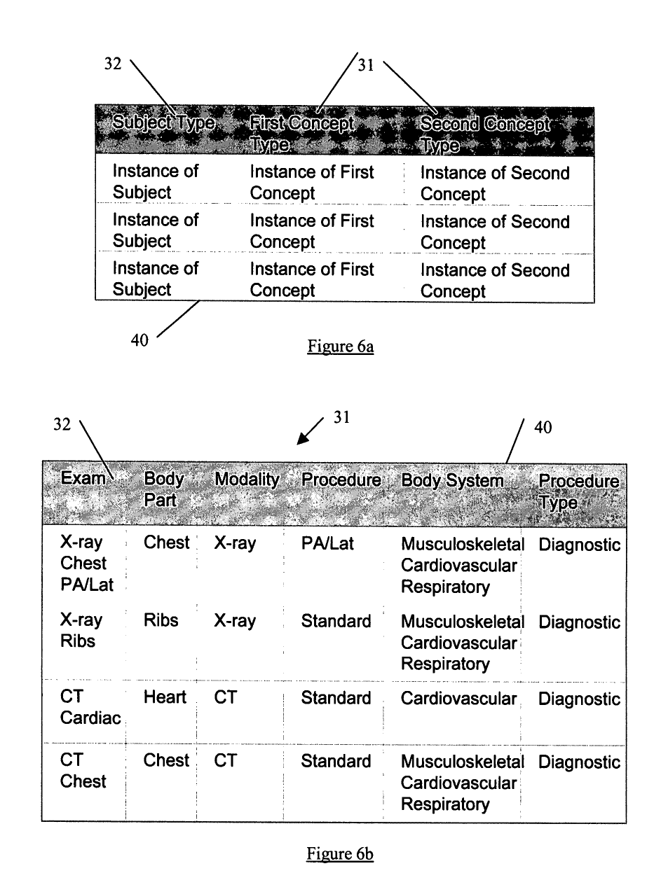

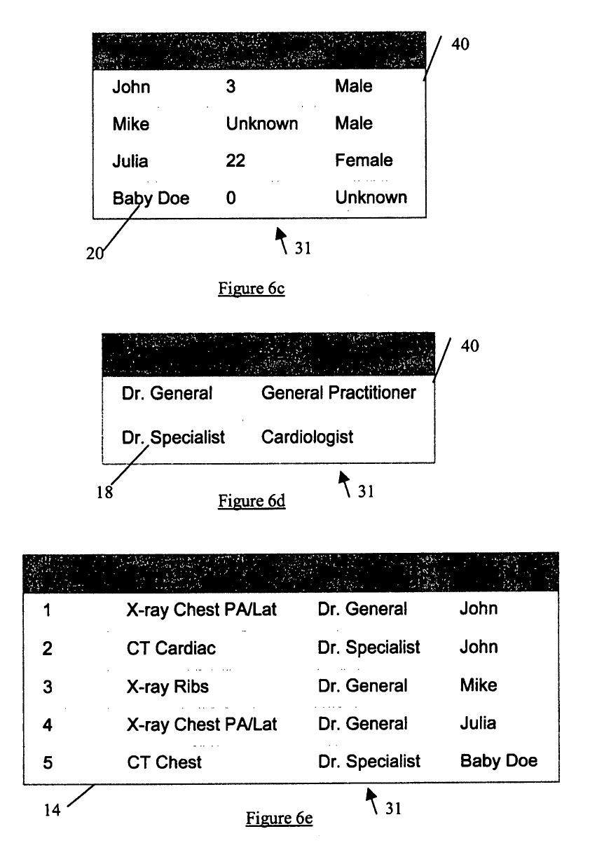

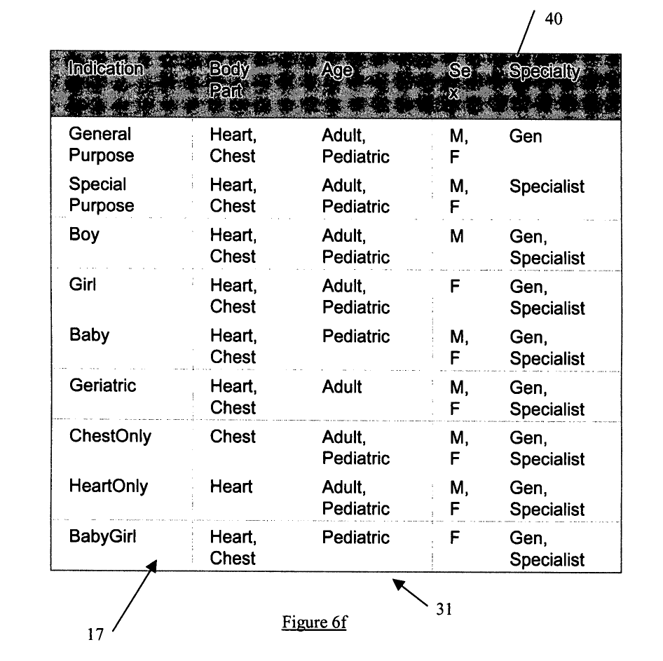

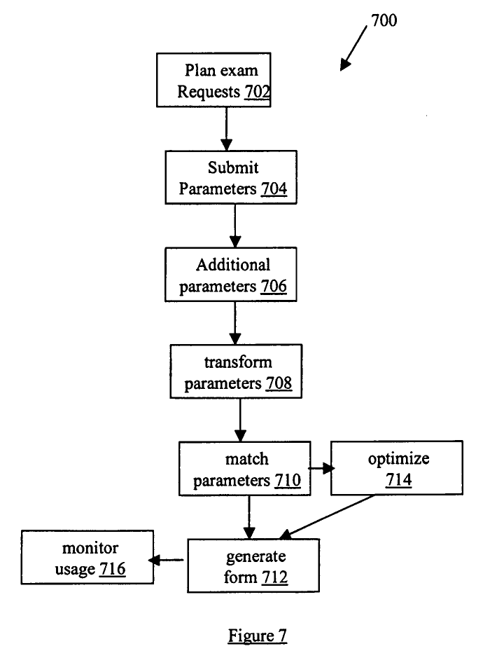

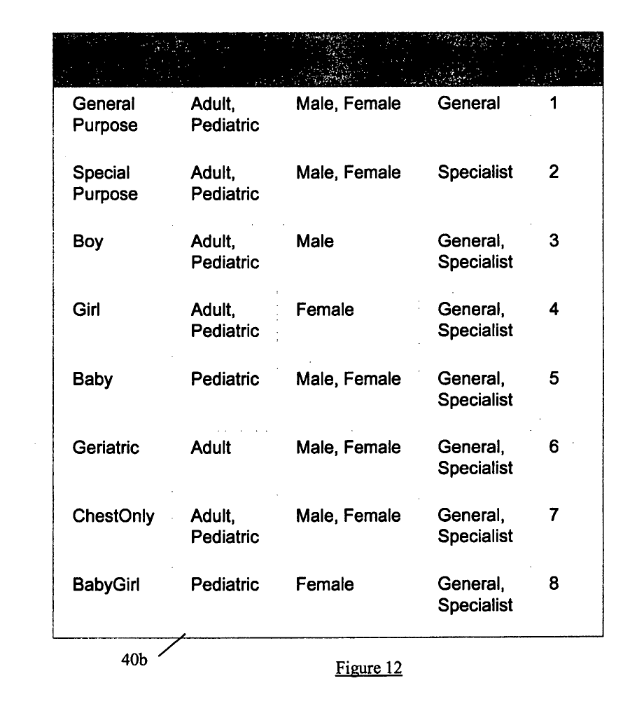

As an example, we look at the same nine statements 17 (see FIG. 6f), but now allow the age, sex, and specialty settings to vary per body part. Let's start with a direct equivalent translation where we simply create two tables 40a, 40b, see FIGS. 11 and 12, one for each body part namely the heart 40a and the chest 40b. It is the same information as in FIG. 6f, but in two tables 40a,b.

Note that each table 40a,b only has eight statements each, not the original nine, because not all statements 17 are used for all body parts. If you focus on just the statements 17 that are relevant to the heart, you do not see the “ChestOnly” statement. Similarly, you don't see “HeartOnly” statement when you look at statements 17 related to the chest only. In this example, the reduction effect is not impressive, since you only eliminate one statement 17. However, in practice the numbers will demonstrate why this idea is advantageous. There may be 2000 or more statements 17, and the user would be looking at about 100 per body part. This is a manageable number to organize into the forms 9.

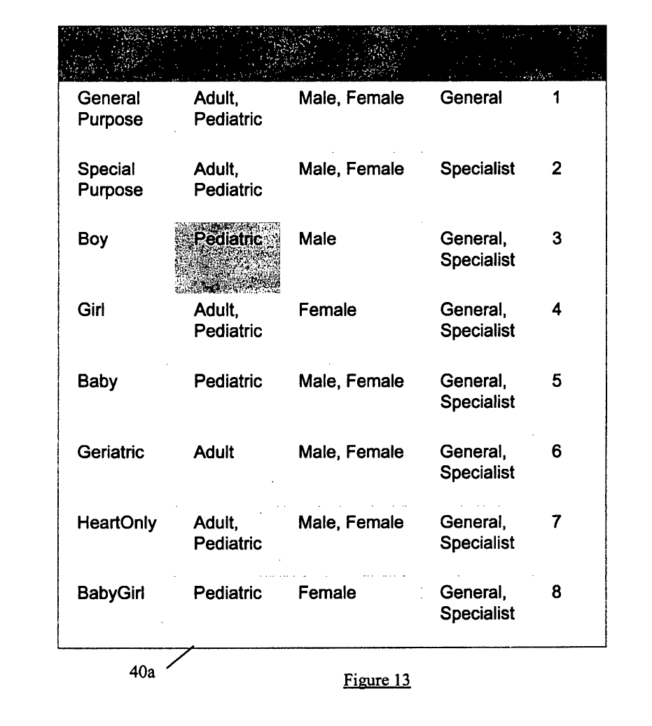

The hierarchy 50 is useful when one views the statements 17 that are available for a particular body part, such that one can set the other concepts 31, e.g. age, sex, and specialty. It is possible that one sets these concepts differently per body part. For example, referring to FIGS. 11 and 13, suppose we decide that the statement “Boy” is only for the paediatrics age on the heart form 40a. We can make this change without changing anything on the chest form 40b (see FIG. 12). This change is demonstrated in the 3rd row of the modified heart table 40a in FIG. 13 (see the shading).

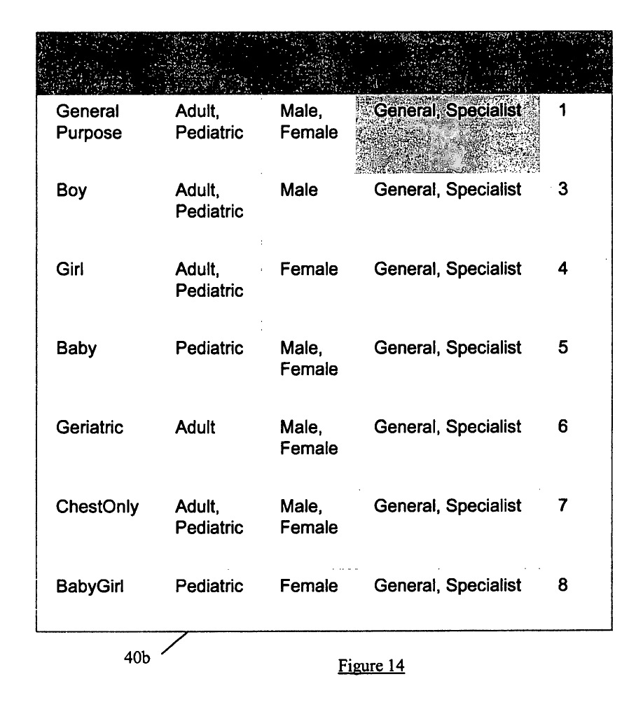

As another example, we can make a change that applies only to the chest form via table 40b. Suppose on the heart table 40a we leave it as is where “GeneralPurpose” is for generalists, and “SpecialPurpose” is for specialists as shown above in FIGS. 11 and 13. But on the chest form, via table 40b we can change the concepts 31 assigned such that both generalists and specialists get the “GeneralPurpose” statement, and the “SpecialPurpose” statement is not needed any more. The change is demonstrated in the 1st row (see the shading), and by deleting the 2nd row, see modified table 40b of FIG. 14.

It is recognised that the hierarchy 50 can also be used in operation of the matching module 404 (see FIG. 4). As mentioned below in the operation of the tool 12, see FIG. 7, a complication can be where “Ribs” is translated as “Chest” but “Heart” is not translated as “Chest. Instead of simultaneously matching all of the concepts 31 on an order 14 with all of the concepts 31 on the statements 14, the matching module 404 can use the hierarchy 50 to perform the matching process in a number of sub steps, for example in the following two steps.

Step 1: Match the exam type 22 of the order 14 to find the right statement sets 16 (e.g. statement superset); and

Step 2: Match the age, sex, and specialty concepts 31.

To illustrate this, consider the chest 40b and heart 40a tables, see FIGS. 11 and 12. We associate with each a simple rule matching rule 53 (see FIG. 4), as follows: if the exam type 22 uses body-part chest or a part of the chest, the chest table 40b is used (e.g. chest statement superset 16), otherwise if the exam type 22 uses body-part heart or a part of the heart, the heart table 40a is used (e.g. heart statement superset 16). The second rule 53, concerning the heart, is more specific than the rule 53 concerning the chest. Because of this specificity we can specify that the heart rule 53 should be used if it applies instead of the chest rule 53. If an exam type 22 is of the ribs, since there is no specific rule 53 for ribs, we use the rule 53 for chest. That is why exams of the ribs get the chest form, but exams of the heart do not.

To this point we have simplified matters through the hierarchy 50 by only using the body part concept 31 on statements 17, and not the others, e.g. modality, body system, procedure, and procedure type. In one embodiment, these extra concepts 31 are not assigned to the statements 17, instead they are assigned to the exam types 22 only. Accordingly, we use these concepts 31 in the rules 53 that match exam types 22 to statement sets 16, as described above. For example, we might have a rule 53 that says if the exam type 22 uses body system gastrointestinal, the gastrointestinal statement set 16 is used. Now, suppose the tool 12 is requested to generate the statement form 9 for an examination that looks at the upper part of the gastrointestinal system that runs through the chest. Now the chest rule 53 and the gastrointestinal rule 53 would both apply. But there may be the constraint of only one statement set 16 per exam request 14. Again we can solve this problem by defining one rule 53 to override the other. This time one isn't clearly more specific than the other, but we can still use this solution to choose which seems better. Other rule 53 solutions are also possible, such as defining a new statement set 16 that is used only for exam requests 14 of the chest that focus on the gastrointestinal body system. It is recognised that there are trade-offs here in that one doesn't want to create too many different statement supersets 16, as this gets hard to manage, but one also doesn't want to use statement supersets 16 that don't fit the exam request 14 well.

In any case, this example of using the body system as the hierarchy 50 also applies to the other concepts 31. This leads to another caution, however. If one uses all the concepts 31 in rules 53 that define which exam requests 14 get which statement supersets 16, the number of statement supersets 16 can increase and the tables 40 can become difficult to manage.

Concept Set 30

Referring again to FIG. 1, lists for various types of concepts 31, are stored in the concept set 30, such as but not limited to: modality; body part; body system; procedure type/modifier; specialty; sex; age; and other patient health factors. Further, it is recognised that the concepts 31 can be assigned to each of the statements 17 according to a concept category, such as but not limited to: patient information (e.g. age, sex, health related); medical practitioner specialty; and exam information (e.g. modality, body part, body system, etc.).

Examples of the modality can include a course-grained distinction of six modalities, for example:

X-ray (applicable to identification of skeletal trauma/characteristics)

CT (applicable to identification of skeletal and soft tissue trauma/characteristics)

MRI (applicable to identification of soft tissue trauma/characteristics)

Radiofluoroscopy

Ultrasound

Nuclear Medicine

Examples of the body parts can include selected body parts forming a hierarchy, wherein some body parts can be divided into subparts (to the right and down):

| Head | Orbit | | |
|---|---|---|---|
| | Sinus | | |
| | Mastoid | | |
| | Nasal Bones | | |
| Neck | | | |
| Entire Spine | Cervical | | |
| | Thoracic | | |
| | Lumbar | | |
| | Sacral | | |
| Chest | Sternoclavicular Joint | | |
| | Sternum | | |
| | Ribs | | |
| | Heart | | |
| Breast | | | |
| Abdomen | Appendix | | |
| Pelvis and | | | |
| Hip | Pelvis | Scrotum | |
| | Hip | | |
| | | | Glenohumeral |
| Extremities | Upper | Shoulder | Joint |
| | | | Scapula |
| | | | Brachial |
| | | | Plexus |
| | | Acromioclavicular Joint | |
| | | Clavicle | |
| | | Humerus | |
| | | Elbow | |
| | | Forearm | |
| | | Wrist | |
| | | Hand | Thumb |
| | | | Fingers |
| | Lower | Femur | |
| | | Knee | |
| | | Tibia/Fibula | |
| | | Ankle | |
| | | Foot | |

Another embodiment of the body parts/regions in the hierarchy 50 can be such as but not limited to: Head—Skull, Brain, Eye, Ear; Neck; Torso—Chest, Breast, Abdomen, Pelvis; and Extremities. such that head, neck, torso, and extremities are the first levels of the hierarchy.

Examples of body systems can be:

musculoskeletal

cardiovascular

neurologic

urologic

lymphatic

respiratory

gastrointestinal

endocrine

reproductive

Examples of specialties could be divided into the following, and possibly others:

Cardiology

Endocrinology

Gastroenterology

General Surgery

Gynecology

Hematology

Nephrology

Neurology

Neurosurgery

Oncology

Ophthalmology

Orthopedic Surgery

Otolaryngology (ENT)

Plastic Surgery

Radiology

Respirology

Rheumatology

Urology

On the other hand, one could keep it simpler, and simply distinguish any specialty from general practice. Further, it is recognised that to tailor the statements 17 to the ordering context of the statement forms 9, all clinical concepts 31 that apply are assigned to each statement 17 of the list 33 (for example by a system administrator—not shown). This assignment of clinical concepts 31 to the statements 17 can be done using a variety of methods, for example such as but not limited to: one can take advantage of the fact that not all factors need to be explicitly selected for, for example, one can assume that patient sex will not matter by using a default that says that each statement 17 is assumed to apply to both sexes; one can assume that patient age will not matter by using a default that says that each statement 17 can apply equally well regardless of patient age; for modality it can be better not to restrict statements 17 on the basis of modality, since most decision support rules can be used to evaluate the choice of modality.

### Metadata

One example embodiment of the concepts 31 is metadata, such that the concepts are applied as attributes of the subjects 32. For example, the metadata concepts 31 can be assigned to the definitions of the subjects 32 as metadata tags using any suitable structured definition language (e.g. XML). The tags can be single/multiple alpha and/or numeric descriptors (e.g. words) used to categorize or otherwise label the subjects 32 so that the matching module 404 (see FIG. 4) can match the parameters 402 with the statements 17 of the statement list 33. The tags can be (relevant) keyword(s) or term(s) or phrases associated with or otherwise assigned to the subjects 32, thus describing the subjects 32 and enabling a descriptive/keyword-based matching of the parameters 402 with the statements 17. The tags can refer to metadata descriptive information associated with the subjects 32 as internal and/or external links, involving the association of descriptors with objects, and can be embodied as the syntax (e.g. an HTML tag/delimiter such as a coding statement) used to delimit the start and end of an element, the contents of the element, or a combination thereof.

The tags can be defined using a structured definition language such as but not limited to the Standard Generalized Markup Language (SGML), which defines rules for how a document can be described in terms of its logical structure (headings, paragraphs or idea units, and so forth). SGML is often referred to as a meta-language because SGML provides a “language for how to describe a language.” A specific use of SGML is called a document type definition (DTD), which defines exactly what the allowable language is. For example, Hypertext Markup Language (HTML) is an example of a structured definition language for defining the tags. A further example of the structured definition language is Extensible Markup Language (XML), which defines how to describe a collection of data. Accordingly, the tags can be used to provide an underlying definition/description of the subjects 32.

There can be several kinds of tag types useful for indexing the subjects 32, tags such as but not limited to a keywords meta tag and a description meta tag. The keywords meta tag can be used to list the words or phrases that best describe the contents/attributes of the subject 32. The description meta tag can be used to include a brief one- or two-sentence description of the subject 32. It is recognised that both the keywords and the description, of the tags, are used by the matching module 404 to identify, and return, the statement set 16 appropriate to the supplied parameters 402 representing the context desired by the user for the statement form 9.

### Tag Examples

The following are example of tags.

<META name=“description” content=“a description of the subject 32”>
the description type tag can be displayed along with the title of the subject 32 in an index. “content” could be a word, sentence or even paragraph to describe the subject 32.

<META name=“keywords” content=“a, list, of, keywords”>
the keywords type tag can include one or more descriptive keywords, separated by commas. The keywords can include synonyms, colloquialisms, and so on.

### Computer Devices 101

### Data Processing System 100

Referring to FIGS. 1 and 3, each of the components of the tool 12 and associated components can be implemented on one or more respective data processing systems 100 of computing device(s) 101, in order to facilitate interaction with the generated statement form 9 displayed on a visual interface 99. The data processing system 100 for the tool 12 has a user interface 108 for facilitating interaction with the tool 12 by a user, the user interface 108 being connected to a memory 102 via a BUS 106 of a device infrastructure 111. The interface 108 is coupled to a processor 104 via the BUS 106, to interact with user events 109 to monitor or otherwise instruct the operation of the tool 12 via an operating system 110. The user interface 108 can include one or more user input devices such as but not limited to a QWERTY keyboard, a keypad, a trackwheel, a stylus, a mouse, and a microphone. The visual interface 99 is considered the user output device, such as but not limited to a computer screen display. If the screen is touch sensitive, then the display can also be used as the user input device as controlled by the processor 104. Further, it is recognized that the data processing system 100 can include a computer readable storage medium 46 coupled to the processor 104 for providing instructions to the processor 104 and/or the tool 12. The computer readable medium 46 can include hardware and/or software such as, by way of example only, magnetic disks, magnetic tape, optically readable medium such as CD/DVD ROMS, and memory cards. In each case, the computer readable medium 46 may take the form of a small disk, floppy diskette, cassette, hard disk drive, solid-state memory card, or RAM provided in the memory 102. It should be noted that the above listed example computer readable mediums 46 can be used either alone or in combination. Further, it is recognized that the visualization tool 12 is an example embodiment of an examination generation application (including subsequent coordination of medical practitioner 18 interaction with the generated statement form 9), which can contain a number of modules for implementing the various attributes and functionality associated with generation and/or interaction of the statement form 9, as described with reference to the Figures.

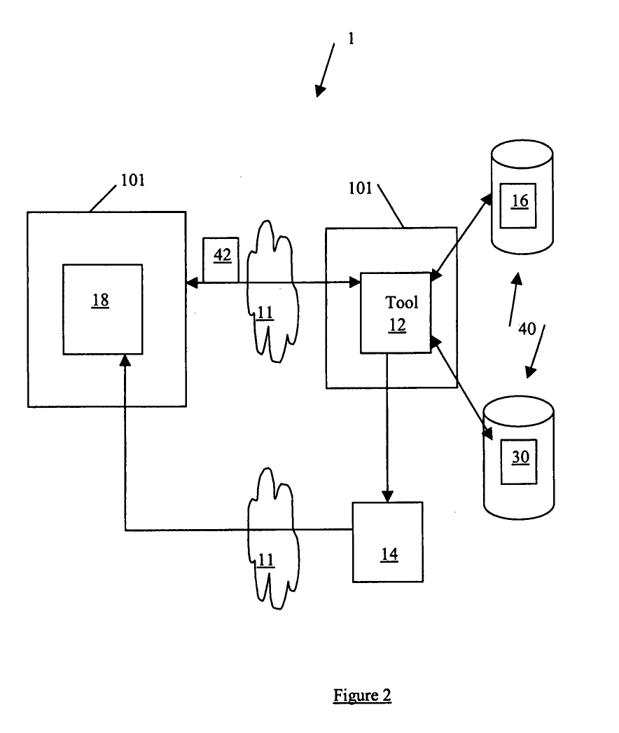

The devices 101 include a network connection interface 107, such as a network interface card or a modem, coupled to the device infrastructure 111. The connection interface 107 is connectable during operation of the devices 101 to the network 11 (e.g. an intranet and/or an extranet such as the Internet), which enables the devices 101 to communicate with each other, the medical practitioners 18, and with the associated data sources 40 (see FIG. 2) for coordinating the request and generation of the statement form 9. Referring again to FIG. 3, operation of the devices 101 is facilitated by the device infrastructure 111. The device infrastructure 111 includes one or more computer processors 104 and can include an associated memory 102 (e.g. a random access memory). The computer processor 104 facilitates performance of the device 101 configured for the intended task through operation of the network interface 107, the user interface 108 and other application programs/hardware of the device 101 by executing task related instructions. These task related instructions can be provided by an operating system, and/or software applications (e.g. tool 12) located in the memory 102, and/or by operability that is configured into the electronic/digital circuitry of the processor(s) 104 designed to perform the specific task(s) related to generation and/or interaction with the statement form 9, as desired.

Referring again to FIG. 3, the tool 12 is configured for presenting the generated statement form 9 on the visual interface 99 of the tool 12. The tool 12 also interacts with data from the data files or tables 40 of the memory 102. It is recognized that the data could be stored in the same or separate tables 40, as desired. The tool 12 can receive requests 42 (see FIG. 2) for storing, retrieving, amending, or creating the statement forms 9 via the tool 12, as driven by the user events 109 and/or independent operation of the tool 12. Accordingly, the tool 12 coordinates the processing of the data of the tables 40 and user events 109 with respect to the content of the statement form 9 displayed in the visual interface 99.

Further, it is recognized that the computing devices 101 can include the executable applications (e.g. one embodiment of the tool 12) comprising code or machine-readable instructions for implementing predetermined functions/operations including those of an operating system, for example. The processor 104 as used herein is a configured device and/or set of machine-readable instructions for performing operations as described by example above. As used herein, the processor 104 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 104 may use or comprise the capabilities of a controller or microprocessor, for example. Accordingly, any of the functionality of the system 100 may be implemented in hardware, software or a combination of both. Accordingly, the use of a processor 104 as a device and/or as a set of machine-readable instructions is hereafter referred to generically as a processor/module for sake of simplicity. Further, it is recognised that the system 100 can include one or more of the computing devices 101 (comprising hardware and/or software) for implementing the modules, as desired. These modules can include modules such as but not limited to the modules 400, 404, 406, 408, 410 as further described below.

It will be understood that the computing devices 101 may be, for example, personal computers or workstations. Further, it is recognised that each device 101, although depicted as a single computer system, may be implemented as a network of computer processors, as desired.

### Memory 102

It will be understood by a person skilled in the art that the memory/storage 102 described herein is the place where data is held in an electromagnetic or optical form for access by the computer processor 104. There can be two general usages: first, memory is frequently used to mean the devices and data connected to the computer through input/output operations such as hard disk and tape systems and other forms of storage not including computer memory and other in-computer storage. Second, in a more formal usage, memory/storage 102 has been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is one embodiment of memory 102 as a collection of information that is organized so that it can easily be accessed, managed, and updated. In one view, databases can be classified according to types of content: bibliographic, full-text, numeric, and images. In computing, databases are sometimes classified according to their organizational approach. The most prevalent approach is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses. Computer databases can contain aggregations of data records or files, such as patient 20 info, catalogues 24, and practitioner 18 profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory/storage 102 can also be defined as an electronic holding place for instructions and data that the computer's microprocessor 104 can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

### Generation Tool 12

Referring to FIG. 4, the tool 12 has a receipt module 400 for receiving from a user (e.g. medical practitioner 18 requesting the examination 14) those parameters 402 (e.g. assigned clinical concepts 31) of the selected examination type 22, patient 20, and/or medical practitioner 18. The parameters 402 are used by a matching module 404 for comparison against the statement concepts SC associated with each of the statements 17 in the statement set 30, in order to determine the set of statements 16 appropriate for the desired statement form 9 (i.e. those statements 17 having concepts SC deemed to match the parameters 402). A generation module 406 uses the set of statements 16 in order to generate the statement form 9 for receipt/interaction by the user (e.g. the medical practitioner 18). The tool 12 can also have a transformation module 408 for transforming the parameters 402 to a predefined format of the concepts 31, in order to facilitate the matching process (e.g. a parameter 402 of “Age=25” would be converted to Age=adult for use in matching to the concepts SC associated with the statements 17). The tool 12 can also have an optimization module 410 for optimizing the placement of the selected statements 16 on the statement form 9, as further described below. It is recognised that the statement form 9, when filled out by the medical practitioner 18 with respective patient 20 specific information, can be included with the exam request 14. The tool 12 can also have a monitoring module 412 for monitoring the patient 20 information entered into the statement form 9 by the medical practitioner, in consultation with the patient 20. The patient 20 information associated with the respective statement(s) 17 can be analysed by the monitoring module 412 and used to dynamically modify the contents of the statements 17 in the statement form 9, as further described below.

### Receipt Module 400

Referring again to FIGS. 1 and 4, the receipt module 400 can be part of the network connection interface 107 (see FIG. 3) of the device 101 operating the tool 12. The module 400 can communicate synchronously or asynchronously with the device 101 of the user 18 over the network 11. The receipt module 400 can receive some or all of the parameters 402 from the user 18. For example, the user 18 can supply the name of the medical practitioner 18 requesting the exam, the name of the patient 20, and the exam type 22 to the receipt module 400. The tool 12 could then access an administration database (e.g. memory 102) to supplement further details (e.g. concepts 31) about the patient 20, medical practitioner 18, and/or exam type 22 as necessary to collect all concepts 31 needed for identifying statements 17 from the statement list 33.

For example, the medical practitioner 18 as a general practitioner (e.g. no specialty) could submit the parameters 402 to the tool 12, in order to receive (or otherwise presented with) desired statement forms 9 for a desired exam type 22, such that the forms 9 contain just those statements 17 that match all of the relevant supplied factors (e.g. parameters 402). For example, suppose a general practitioner 16 orders a chest X-ray type 22 for a male newborn 20. This information can be represented by the following clinical concepts 31: patient name—John Doe; age—newborn; sex—male; specialty—none; modality—X-ray; body-part—chest; and body-system(s)—musculoskeletal, cardiovascular, and/or respiratory. Any supplemental information can be obtained from the memory 102 by the tool 12 (e.g. any relevant details concerning the delivery of the newborn—e.g. premature, physical deformities, etc.). This supplemental information of the patient 20 can be stored in the memory 102 in the form of predefined concepts 31 and/or as descriptive patient information 35 (see FIG. 3). For example, the patient John Doe could also have the additional concept 31 of “birth weight=four pounds” and the descriptive information 35 of “potential lung infection” in the electronic patient file associated with the patient 20 name (John Doe), present in the patient list 26. Accordingly, in the above example, the parameters 402 available to the receipt module 400 would include: patient name—John Doe; age—newborn; sex—male; specialty—none; modality—X-ray; body-part—chest; and body-system(s)—musculoskeletal, cardiovascular, and/or respiratory; birth weight—four pounds; and potential lung infection.

The receipt module 400 would make the parameters 402 available to the matching module 404 and/or the transform module 408, as configured by the tool 12.

### Transform Module 408

Referring again to FIGS. 1 and 4, one embodiment of the transformation module 408 is to amend any identified parameters 402 to match the predefined nomenclature/format of the concepts 31 assigned to the statements 17 in the statement list 33. The transform module 408 could amend the parameters 402 through access to the concept set 30 (i.e. knowledge of predefined concepts 31), as well as a rule set 38 providing logic for use in translating those parameters 402 that do not use the nomenclature/format of the concept set 30. For example, the transform module 408 could identify that the received parameters 402 of: newborn; birth weight—four pounds; and potential lung infection are not included in any of the concepts 31 in the concept set 30. The transform module 408 would then determine whether any rules in the rule set 38 are applicable to transform these identified parameters 402. For example, the rule set 38 could dictate that: newborn translates to “under 1 year”; birth weight—four pounds translates to “weight=4 lbs”; and potential lung infection translates to “lung infection”. These transformed concepts 31 would be used to replace their counterparts in the parameters 402.

It is noted that the transform module 408 could also identify if any of the parameters 402 (e.g. terms, values, phrases) do not correlate with any of the concepts 31 in the concept set 30, i.e. uncorrelated parameters 403. In this case, these uncorrelated parameters 403 could be included in the statement form 9 and identified as such to the medical practitioner 18 on the statement form 9; could be left out of the content of generated statement form 9 without notification to the medical practitioner 18; or could be communicated to an administrator of the statement form environment 1, as desired.

Once transformed, the modified parameters 402 would then be made available to the matching module 404, in order to obtain the statement set 16 consistent with the modified parameters 402.

### Matching Module 404

Referring to FIGS. 1 and 4, the matching module 404 communicates with the statement list 33 in order to facilitate obtaining of statements 17 (as the statement set 16) that are most relevant to the requested exam type 22, based on matching of the parameters 402 with the assigned statement concepts SC. It is recognised that the statements 17 can be resident in the statement list 33 as individual statements 17 and/or as a group of statements 17, as desired. For example, in the extreme, all applicable statements 17 for a desired examination type 22 can be stored in the statement list 33 as one statement 17 group (e.g. one statement group having an assigned list of statement concepts SC for a particular exam type 22).

In general, the matching module 404 can be programmed to receive the parameters 402, compare the parameters 402 to the statement concepts SC in the statement list 33, and return results in the form of the statement set 16. It is recognised that each of the statements 17 may be required to match some or all of the supplied parameters 402 according to their assigned statement concepts SC. To determine what is on the exam 14, the matching module 404 can find all statements 17 that simultaneously match all of (or a respective subset of) the parameters 402. An alternative methodology is where the matching module 404 can look at all statements 17 in the statement list 33 that match the specified body part and/or body system (e.g. musculoskeletal, cardiovascular, and/or respiratory), and then to see which of these apply to the remainder of the parameters (e.g. newborn males when the physician is a general practitioner who has selected an X-ray).

The matching module 404 can also provide a list of statements 17 that do not match the parameters 402 but are noted as frequently included in the statement forms 9 for the requested exam type 22. In this instance, it would be up to the user (e.g. medical practitioner 18) to modify the parameters 402 for a subsequent search (i.e. matching process) of the statement list 33, and/or to otherwise select from the list of unmatched but frequently included statements 17, as desired. The frequency of inclusion in the statement forms 9 could be assigned to the statements 17 as one of the statement concepts SC, as desired.

There are a number of ways that the matching module 404 can be implemented. A first method is where one could treat the forms 9 in a dynamic way, where the matching module 404 figures out which statements 17 should be on the forms 9 as the order is created. In this case, for example, the matching module 404 could be configured as follows: input—a context with all relevant concepts 31 selected as the parameters 402; for each statement 17 in the statement list 33, check if that statement 17 matches all relevant concepts 31 present in the parameters 402 and if so, add the matched statement 17 to the statement set 16; and repeat for all statements 17 present in the statement list 33.

A second method is where the matching module 404 could be configured to interact with precomputed/precompiled forms, e.g. static groups of statement sets 16. The matching module 404 would then be configured to search for all possible combinations of the relevant concepts 31 assigned to each of the statement sets 16 resident in the statement set 16, e.g. stored in a data structure in the memory 102 that allows them to be extracted as follows: input—a context with all relevant concepts selected as the parameters 402; and look up the statement set 16 in the data structure matching all of the relevant parameters 402. For example, one concept 17 could be assigned to the statement group 16 containing a plurality of individual statements 17.

A third method is a combination of the first two methods, which includes both individual statements 17 and groups of statements 17 in the statement list 33. In this case, the statement set 16 would be constructed out of matched individual and group statements 17.

A fourth method is where the matching module 404 finds a superset of statements 17 defined using the body part and body system, and then the matching module 404 would eliminate any unwanted statements 17 based on the remaining relevant concepts 31 as follows: input—a context with all relevant concepts 31 selected as parameters 402; look up the superset form of statements 17 in the data structure using the body part and body system parameters; for each statement in the superset form check if that statement 17 matches the relevant concepts 31 of the parameters 402 or if not then remove the respective statement 17 from the superset form. It is recognised that the fourth method could also include adding wanted statements 17 to the superset as well.

It is recognised in all the above described example methods, the input is the same (i.e. a parameterized 402 input). The input parameters 402 include relevant concepts 31 taken from the current ordering context (i.e. the concept set 30), and the output includes specified statement 17 form(s) as the generated statement form 9.

### Optimization Module 410

Referring to FIGS. 1 and 4, the optimization module 410 can communicate with the generation module 406 for facilitating optimization of the placement of the selected statements 17 of the statement set 16 on the generated statement form 9, based on an optimization rule set 54. For example, the statements 17 can be presented on the form 9 in a particular chosen order (e.g. as part of the parameters 402 and/or via configuration of the tool 12) that makes it as easy as possible to find desired statements 17 by the user. For example, statements 17 can be grouped per body system if the form 9 is intended to apply to multiple systems. If the body part is specified (e.g. “abdomen”), the statements 17 could be organized around the sub-topics of the specified body part (e.g. renal system and the gastrointestinal system). Other possibilities are to use alphabetical order and/or to place items in the statement form 9 in predefined form positions for those statements 17 that are used most frequently, e.g. place frequently used statements 17 at the top of the statement form 9.

Another option is to structure the layout of the statements 17 on the statement form 9 based on the known medical practitioner 18 preferences (e.g. structured approach to patient 20 examination for systematic collection of patient information associated with the statements 17 of the form 9). One example of this is where medical practitioners 18 are known to desire information to certain primary statements 17 first (e.g. current symptoms) followed by desired information to secondary statements 17 next (e.g. medical history). In this case, symptom statements 17 would be placed in a higher priority position on the statement forms 9 over those statements 17 related to medical history.

Another option is for the optimization module 410 to group the included statements 17 on the basis of commonality of symptoms for a respective condition (e.g. pain). For example, if two statements 17 each have a selection of pain as patient specific information, the spaces on the statement form 9 for pain for each of the two statements 17 can be combined as one space for specifying the pain. This combination of statements 17 on the statement form 9 for similar information can help to reduce information overload and/or information cluttering.

Another option is to group statements on the statement form 9 based on the required potential follow-up questions and/or further depth of patient 20 information. For example, secondary statements 17, as further described below, can be triggered based on the patient 20 specific information gathered by the medical practitioner 18 in response to the primary statements 17. One example of primary and secondary statements 17 is statement of pain in a specific body part/region may require follow-up questions related to a different, separate body part/region.

Accordingly, the layout of the statements 17 on the statement form 9 can be optimized to take into account, for example: statement 17 grouping based on a commonality of symptoms/body part/body system; known style/preferences of the medical practitioners 18; combination of statements 17 to reduce clutter or to otherwise efficiently utilize the space on the statement form 9; depth of patient 20 information required; and other reasons as desired.

### Monitoring Module 412

The tool 12 can also have a monitoring module 412 for monitoring the patient 20 information entered into the statement form 9 by the medical practitioner, in consultation with the patient 20. The patient 20 information associated with the respective statement(s) 17 can be analysed by the monitoring module 412 using decision support rules 56 to dynamically modify the contents of the statements 17 in the statement form 9. For example the tool 12 can generate secondary statements 17 based on the analysed patient 20 information. These secondary statements 17 can be embodied, for example, as: additional statements 17 placed on the statement form 9; and/or onto additional statement form(s) 9. These secondary statements 17 can be used to increase the depth of patient 20 information collected via the statement form 9.

The secondary and (and tertiary, etc.) statements 17 are worth noting, as they have to do with the fact that when the medical practitioner 18 places the exam request 14 (e.g. a radiology order), the selection of the statement 17 can serve two or more purposes. The first purpose is where the patient 20 information collected in association with the statements 17 (of the statement form 9) helps other medical practitioners 18 (e.g. the radiologist who looks at the images) to know what to look for. The second purpose is that the patient 20 information collected in association with the statements 17 (of the statement form 9) can be used with decision support rules 56 to help the medical practitioner 18 to decide what advice to give the patient 20 for treatment.

Accordingly, it is recognised that the depth of information required for each of these purposes is not necessarily identical. For example, the amount of patient 20 information required by decision support can be more than the medical practitioner 18 is accustomed to providing for the needs of the radiologist. The tool 12 generates the statement form 9 to have a series of primary/initial statements 17 that the medical practitioner 18 interacts with initially to satisfy the information needs of other medical practitioners 18 associated with the exam request 14 (e.g. the radiologist). Further, the patient 20 information collected with respect to the primary statements 17 could be detailed enough so that decision support rules 56 (as implemented by the monitoring module 412) can determine whether additional information is needed via secondary statements 17. If so, the decision support rules 56 can cause the tool 12 to dynamically update the content of the statement form 9 in order to get the medical practitioner 18 to ask the patient 20 about statement details beyond what was on the primary statement form 9.

In other words, the primary statement forms 9 described above provide enough detail to trigger the decision support rules 56, and secondary statements 17/forms 9 can be generated to gather more patient 20 information, as necessary. The fact that these primary forms 9 are tailored to the context is notable so that the form 9 of the primary statements 17 is as straightforward as possible to fill in by the medical practitioner 18, and provides for a sufficiently detailed understanding of the patient's 20 clinical condition, to allow subsequent follow-up statements 17 where deemed advantageous by the decision support rules 56.

The configuration of the tool 12 described above takes advantage of the expectation that exam requests 14 of similar body parts can share the same statements 17. For example, there may be twenty or more different chest-related exams, where if each respective set of statements 16 was defined independently, it would be difficult to keep them in synch due to periodic updates/changes to the set of statements 16 as well as to the individual statements 17 themselves. Further, the configuration of the tool 12 described above provides for one to use the extra configuration possibilities only when it is advantageous to do so. For example, if there was a good reason to maintain differences between each of these chest-related exams, the tool 12 could do so by defining the superset statements 17 at a finer granularity. This could be facilitated by adding procedural details to the definition of the superset statements 17.

In summary, based on as much as possible of the information available during the order-placing process, the tool 12 is configured (through the manipulation of concepts 31) to tailor an statement form 9 so that it is as useful as possible for use by other medical practitioners 18 (e.g. secondary practitioners such as radiologists). The statements 17 on the statement form 9 can be tailored to the particular physician 18 placing the exam order 14, the patient 20 for which the order is being placed, and the exam being requested.

### Example Operation of the Tool 12

These examples illustrate the logic of how a dynamic statement form 9 is created. Referring to FIG. 6a, shown is an example embodiment of a structured definition of concepts 31 assigned to subjects 32. In each of the tables 40 shown, the left-most column is the subject 32 to which are applied the concepts 31. The columns to the right are the concepts 31 applied to the subject 32. The top row is a heading to show the types of the subjects 32 and concepts 31, and the rows below are instances of these types. That is, each table 40 has the following example structure (although the number of concept 31 columns can vary depending upon how many concept 31 types are applied to each subject 32 type). Referring to FIG. 6b, we have the following example exam types 22, each having one body part, one modality, and more than one body system. Referring to FIG. 6c, shown are four example patients 20, each having the concepts 31 of age and sex. However, there may be missing some information, and so some concept 31values are listed as “Unknown”. Referring to FIG. 6d, shown are two physicians 18. Referring to FIG. 6e, shown are a few example orders (exam requests 14).

Referring to FIG. 6f, shown is an example statement 17 context. Suppose we have set up the number of statements 17 as follows. Normally there would be a lot more statements 17 to fill out the statement form 9, but just a few are shown for exemplary purposes only. Artificial names can be used for the statement 17 instances that make it easy to remember the relationships between the statement 17 and the concepts 31. More realistic statement 17 instances would include examples such as “Aneurysm”, “Pain”, and “Asthma”.

Referring to FIG. 7, shown is an example operation 700 of the tool 12, configured so as to tailor a statement form 9 (e.g. for display on the visual interface 99—see FIG. 2) so that it is as useful as possible to the medical practitioner 18. The information of the form 9 can be tailored to the particular physician placing the order, the patient 20 for which the order is being placed, and the exam being requested.

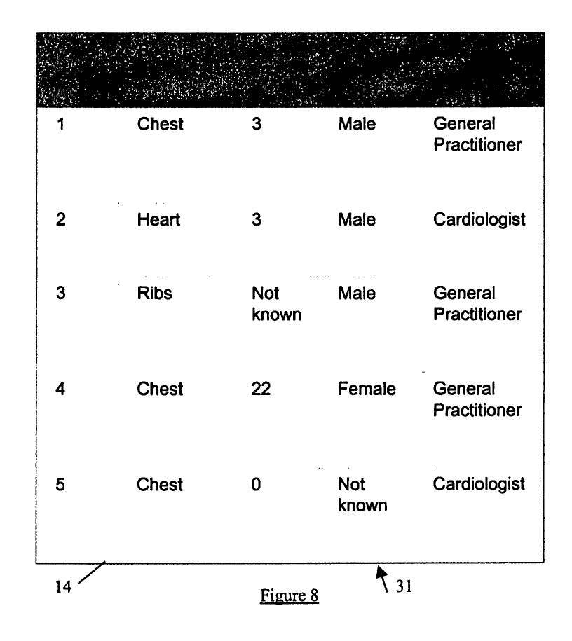

At step 702, example exam requests 14 are planned for the respective patients 20, exam types 22 and medical practitioners 18 as shown in FIG. 6e. At step 704, the parameters 402 of the exam requests 14 are supplied to the tool 12. At step 706, the tool 12 accesses the tables 40 of the memory to obtain additional concepts 31 related to the patients 20, exam types 22 and/or medical practitioners 18 specified in the parameters 402 for each of the five exam requests 14, where applicable to result in the example parameter list shown in FIG. 8.

### Step 708

In calculation of what statements 17 are included on the statement forms 9, at step 708 some translations are done in order to have the concepts 31 on the order 14 use the same concept 31 terms as on the statements 17 in the statement list 30. Accordingly, the tool 12 for example translates the reference to “General Practitioner” to “General” as is known from the concept set 30. One reason for the mismatch between the order 14 and the statements 17 is that the information on the order 14 may be more specific than the set of concepts 31. For example, on the order 14 we can have the age of the patient 20 in years, but on the statements 17 we only care whether the age falls into the paediatric category or not. For example, the body part concept 31 is defined using the hierarchical structure 52. The hierarchy 52 defines which body parts are parts of other parts. For example, the sinus is part of the head. In the present example, we define body parts “Heart” and “Chest” on the statements 17. The order 14 uses these, but also “Ribs”. Therefore, since “Ribs” is a part of “Chest”, the tool 12 translates “Ribs” on the order 14 to “Chest”. For example, we need to know that although the “Heart” is part of the “Chest”, we do not make the translation in this case as the translation rules 38 dictate that heart is a special category separate from the chest. Accordingly, after translation there exists similarity between the body part on the order 14 and on the statements 17.

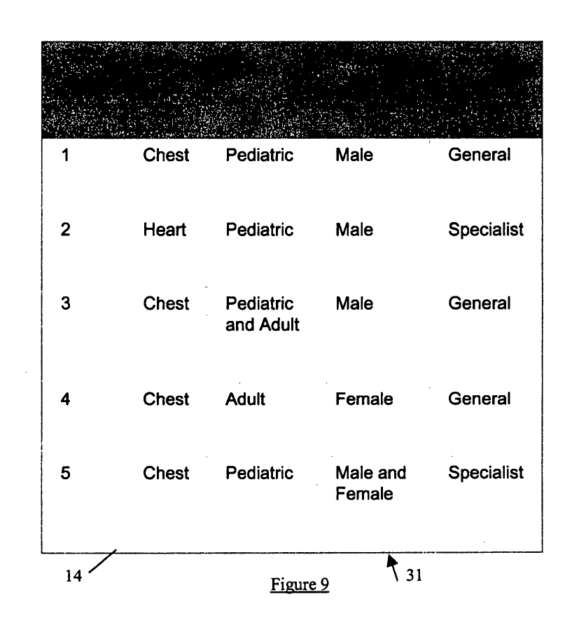

Patient age on the order 14 can be derived from the patient birth date obtained from the memory 102 by the tool 12. On the statements 17, the representation of age is transformed to distinguish adult from paediatric. The distinction is based on the age of the patient such as 16 or less counts as paediatric, and 17 or greater counts as adult. It is noted that if age information is missing (e.g. we don't have the birth date) then the age is transformed as both. On the example statements 17, we are simplifying sex by only representing male and female. We do not have separate representation for unknown sex or any other option that may exist. To translate, the tool 12 uses the rule 38 that if an instance of the concept 31 sex is used besides male or female, we do not use sex as a factor in the matching process. Or equivalently, it would count as either male or female on the order 14, so unknown sex is translated as both male and female on the statements 17. In the example, physicians 18 have their specific specialty represented on the order 14. However, on the statements 17, we only care about whether they are a generalist or specialist, hence the necessary specialty translation. In any case, the end result is that the parameters 402 are transformed from the values in FIG. 8 to the values in FIG. 9.

### Step 710

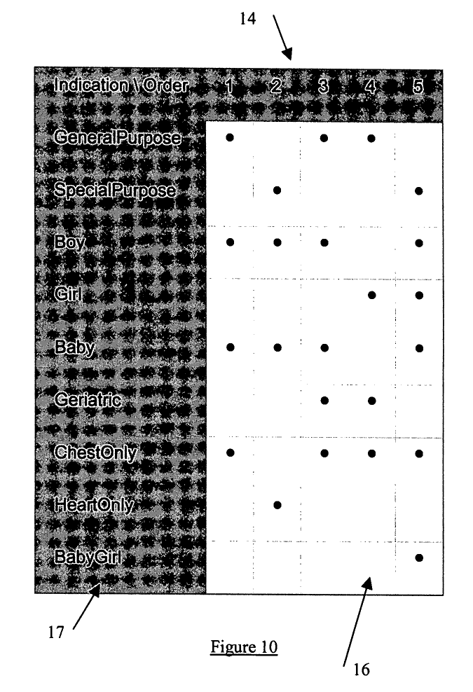

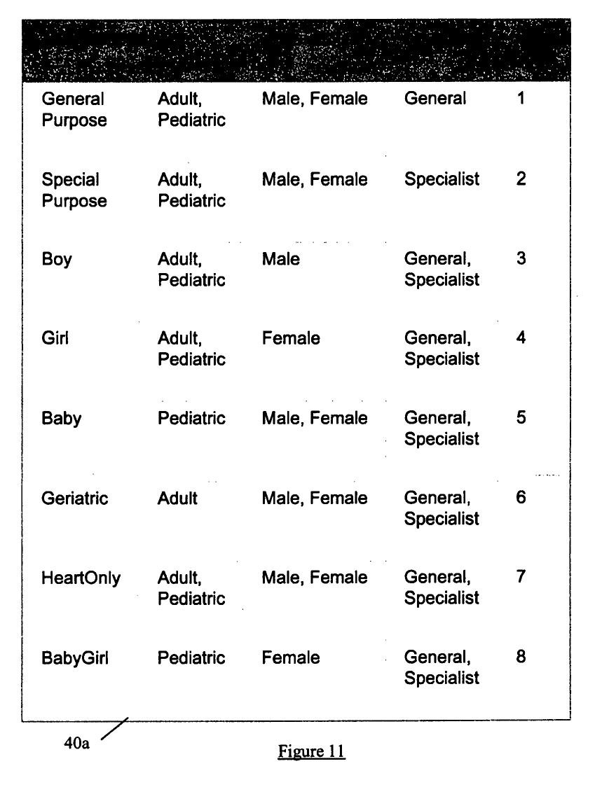

Referring to FIG. 7, at step 710 the matching module 404 matches the parameters 402 with the concepts 31 assigned to each of the statements 17 of the statement list 33 to result in matched statement sets 16 for each of the orders 14, see FIG. 10. For all of the concepts 31, body part, age, sex, and specialty, the tool 12 includes the respective statement 17 if the instance of the concept 31 on the order 14 is included as one of the instances of the same concept 31 on the statement 17. For example, shown are all matches between the statements 17 and the orders 4. Notice that each order 14 (each column) has a different set of statements 16 on the form. To help explain how this table is generated, consider a couple of rows. The rest are just as easy to generate. GeneralPurpose: this statement 17 matches both body parts, both ages, both sexes, but only one specialty, “General”. So this statement 17 is on the form 9 for all orders 14 that have “General”, e.g. orders 1, 3, and 4. BabyGirl: this statement 17 matches both body parts, and both specialties, but only age “Paediatric”, and sex “Female”. So this statement 17 is on the form 9 of order 5 only.

At step 712 the matched statements 17 as the statement set 16 are supplied to the generation module 406 for use in generating the statement form 9 for supplying to the medical practitioner 18. Optionally, at step 714, the optimization module 410 optimizes the placement and/or format of the statements 17 in the statement form 9. At step 716, the monitoring module 412 monitors the interaction of the medical practitioner 18 with the statement form 9 for auditing and data mining purposes for supplying data 808 (see FIG. 17), as further described below.

### Implementation Models of Statement System 1

### Stand-Alone Implementation

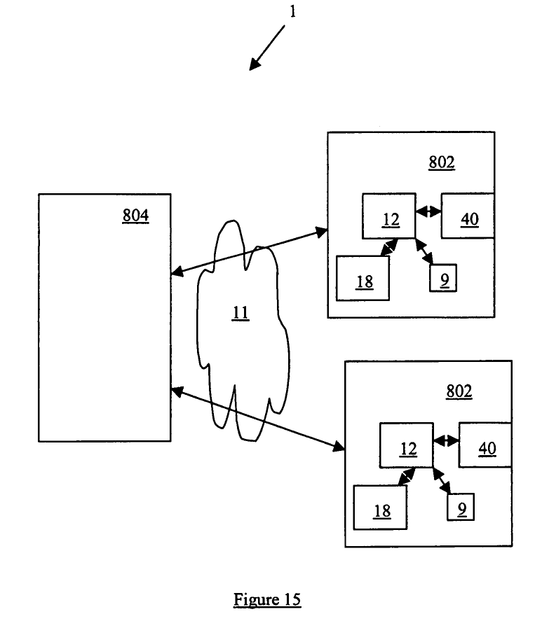

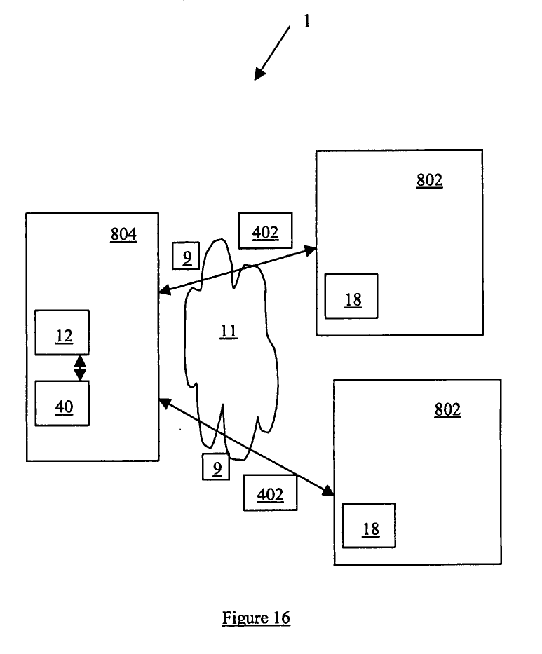

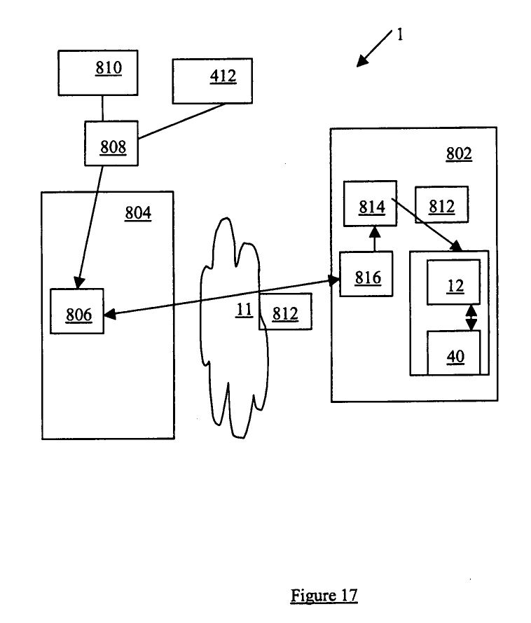

Referring to FIGS. 15 and 16, the statement environment 1 can be implemented via a number of different implementation models. FIG. 15 shows the tool 12 implemented as a client side utility of one or more clinical sites 802 (e.g. hospitals), such that the tool 12 has local interaction (for example over an intranet of the clinical site 802—not shown) with the medical practitioner 18; and the tables 40 (see FIG. 3) containing the statement lists 33, patient 20 and practitioner 18 information 26,28, the exam information 24, and the concept set 30; in order to facilitate generation of the statement form 9 tailored to the parameters 402 initiated by the practitioner 18 (for example). Each of the clinical sites 802 can have interaction with a central administration system 804 for the purposes of maintaining the content of the statement list 33, the concept set 30, and/or the configuration of the various modules and rule sets of the tool 12, as further described below.

It is recognised in this implementation model that each of the clinical sites 802 can have their own customized list of statements 33, concept set 30 and rule sets 53,54,56, for example, in the memory 102. However, it is recognised that the generation of the statement forms 9 in each of the clinical sites 802 is dynamic, as described above, based on the supplied parameters 402 and related information in the memory 102 (see FIGS. 3 and 4). For example, each of the clinical sites 802 can have the list of statements 33 and the concept set 30 configured so as to allow for the dynamic generation of specific sets of statement forms 9 particular to their practiced branch(es) of medicine. One example of this is for specific body parts (e.g. head vs. extremities) for which the medical practitioners 18 of the clinical site 802 specialize, e.g. an Otolaryngology clinic 802 specializing in treating ear, nose, throat, and head & neck disorders, as compared to a podiatrist clinic 802 specializing in medical and surgical treatment of feet.

### Client-Server Implementation

Referring to FIG. 16, the tool 12 is implemented in a client-server relationship with each of the clinical sites 802. The administration system 804 can host the aspects of the tool 12 responsible for generation of the statement form 9, which once generated is sent over the network 11 to the requestor (e.g. medical practitioner 18) through the clinical site 802 (for example). The tool 12 receives the parameters 402 from the medical practitioner 18 (in the form of a request) similar to that described above. It is recognised in the client-server model that the administration system 804 could host multiple versions of the various modules of the tool 12 and various versions of the list of statements 33, concept set 30 and rule sets 53,54,56, for example, in the memory 102, such that each of the versions would be customized for the particular requirements of the individual client sites 802. For example, one example of this is for specific body parts (e.g. head vs. extremities) for which the medical practitioners 18 of the clinical site 802 specialize, e.g. an Otolaryngology clinic 802 specializing in treating ear, nose, throat, and head & neck disorders, as compared to a podiatrist clinic 802 specializing in medical and surgical treatment of feet. It is recognised that the monitoring module 412 (see FIG. 4) may be implemented on the client side (e.g. on the clinical site 802 computer systems) separately from other modules of the tool 12, in order to monitor the usage of the generated form 9 by the medical practitioner 18 and to report any results of this monitoring back to the administration system 804 over the network 11 (e.g. to report frequency of use for selected statements 17 for selected exam types 22).

In view of the above-described example implementation models, it is recognised that the content of the statement lists 33 and the concept sets 30 (for example) can be the same for each of the clinical sites 802. In this case, each of the entries in the statement lists 33 and/or the concept sets 30 would have an activation/deactivation operational parameter. Implementation of this operational parameter would be such that if set as activated, the respective concept(s) 31 and/or statement(s) 17 would be included in the operation of the tool 12 in generation of the statement forms 9. On the flip side, if set as deactivated, the respective concept(s) 31 and/or statement(s) 17 would not be included/considered through the operation of the tool 12 in generation of the statement forms 9. It is also recognised that the each concept in the concept set 30 can have a respective operational parameter, each statement 17 in the statement list 33 can have a respective operational parameter, and/or each concept 31 in the statement list 33 associated with a particular statement 17 (or group of statements 17) can have a respective operational parameter. It is recognised that suggested changes 812, described below, could be used to configure these operational parameters as desired. For example, rather than delete an statement 17 from the content of the statement list 33, the changes 812 could be used by the configuration tool 814 to change the operational parameter for the statement 17 from activate to deactivate, thus effectively removing the statement 17 from consideration in generation of the statement forms 9.

### Administration of Statement Environment 1

Referring to FIG. 17, shown is an embodiment of the administration system 804 of the statement environment 1 (see FIG. 1). The administration system 804 has an administration module 806 responsible for maintaining the operation of the environment 1, with respect to either implementation model shown in FIGS. 15 and 16 by example. Specifically, the administration module 806 receives data 808 from third party sources 810, and/or from the monitoring module 412, concerning potential changes/updates to the configuration of the tool 12 and the associated tables 40 (see FIG. 3). These potential changes/updates are fed back into the configuration of the statement environment 1, leading to changes that facilitate the operation of the statement environment 1 to become more suitable over time. The administration module 806 can communicate with a configuration tool 814 that is responsible for implementing suggested changes 812 to the tool 12 and/or the tables 40 stored in the memory 102, as further described below. It is recognised that the location of the configuration tool 814 could be either on the administration system 804 side or the clinical site 802 side of the network 11, as desired. The changes/updates 812 could be confirmed by a confirmation module 816 prior to implementation, as desired.

It is recognised that the suggested changes/updates 812 can be such as but not limited to: removal of an statement 17; addition of an statement 17; activation or deactivation of an existing statement 17; and amendment of the content of the tables 40.

It is recognised that creating good tailored statement forms 9 is facilitated by a comprehensive statement list 33 and/or concept set 30. The data 808, useful in updating of the statement lists 33 and concept sets 30 used by the tools 12 of the clinical sites 802, can come from the following data sources, such as but not limited to: orders that were created using the system of allowing the user to enter free text statements can be mined to find commonly-used statements 17; ordering physicians and radiologists that know by experience what statements 17 they tend to use or see; published decision support guidelines as sources of statements 17 because they define clinical conditions under which clinical advice can be provided, where these clinical conditions correspond to a set of statements 17; and other published medical literature.

It is recognised that once the statement lists 33 and concept sets 30 are created, they can be used in the live and dynamic environment 1. Accordingly, by auditing and data mining the usage of the statement lists 33 and concept sets 30 (e.g. via the monitoring module 412 and/or other third party sources 810), the administration module 806 can learn which statements 17 were used frequently, which were not, and which statements 17 were missing. The latter can be determined when users type in free text in the statement form 9 when the statement 17 they want is not available. The administration module 806 can also learn from direct feedback from users (e.g. third party sources 810) who complain about the lack of certain statements 17 that they would otherwise use, including undesirable format and/or placement of the statements 17 in the forms 9.

In view of the above, the administration module 806 is used to take the data 808 and look for potential patterns applicable with a view to upgrading/improving the operation of the statement environment 1. The administration module 806 would then communicate the suggested changes 812 to the clinical sites 802 in order to obtain an acceptance of the suggested changes/updates to the statement lists 33 and concept sets 30, e.g. via the confirmation module 816. It is recognised that the changes 812 are not for individual statement forms 9 but for the primary components (e.g. statement lists 33 and concept sets 30) used to construct the statement forms 9, based on the configuration of the modules and rule sets of the tools 12.

For example, the administration module 806 could publish changes to statements 17 in such a way that the clinical site 802 could view them first before deciding to accept them via the confirmation module 816. In this case, the administration module 806 would act as a publishing tool and the configuration tool 814 and/or the confirmation module 816 would act as a subscribing tool, which would facilitate the provision of reasons for subscribing to a suggested change/update. For example, it may be good to accept a change if it will improve the usage of a decision support rule or other rule sets of the tool 12. One advantage of this publication-subscription paradigm is that where there are many users, it requires a similar amount of work regardless of the number of users.

We claim:

1) A system for generating statements for use by a user in collecting clinically relevant information about a patient for a selected examination type, the system comprising:
a storage including a plurality of statements having statement concepts assigned to each of the plurality of statements, the statement concepts being descriptors for defining each of the plurality of statements;
a receipt module configured for receiving a request having at least one parameter including an exam concept associated with the selected exam type for defining a characteristic of the selected exam type;
a matching module configured for comparing the exam concept to the statement concepts assigned to each of the plurality of statements, the comparison for selecting matching statements from the plurality of statements having the exam concept, the comparison resulting in a statement set containing the matched statements; and a generation module configured for generating a statement form including the statement set, the statement form for use by the user in collecting the clinically relevant information about the patient.

2) The system of claim 1, wherein the parameters of the request further include at least one medical practitioner concept for defining a characteristic of a selected medical practitioner as the user the at least one medical practitioner concept for use in comparing to the statement concepts assigned to each of the plurality of statements.

3) The system of claim 2, wherein parameters of the request further include at least one patient concept associated with the patient for defining a characteristic of the patient, the at least one patient concept for use in comparing to the statement concepts assigned to each of the plurality of statements.

4) The system of claim 3, wherein the exam type is selected from the group comprising: body part; body system; and body region.

5) The system of claim 4, wherein the exam type is further selected from the group comprising: modality type and procedure.

6) The system of claim 4, wherein the statement is selected from the group comprising: a question; answer to a question; a topic; a sentence; a phrase; a circumstance; and a menu selection.

7) The system of claim 5 further comprising a concept hierarchy for organizing the statement concepts into a hierarchical order based on a plurality of concept categories.

8) The system of claim 7, wherein the concept categories are selected from the group comprising: body part; body system; and body region.

9) The system of claim 8, wherein the concept categories are further selected from the group comprising; exam modality including exam type; procedure type; procedure modifiers; specialty definition of the medical practitioner; patient sex; patient age; user type; and patient health factors.

10) The system of claim 8, wherein at least one of the body part, the body region, and the body system concept categories is the highest concept category in the hierarchical order of the concept hierarchy.

11) A method for generating statements for use by a user in collecting clinically relevant information about a patient for a selected examination type, the method comprising the acts of:
assigning statement concepts storage to each of a plurality of statements, the statement concepts being descriptors for defining each of the plurality of statements;
receiving a request having at least one parameter including an exam concept associated with the selected exam type for defining a characteristic of the selected exam type;
comparing the exam concept to the statement concepts assigned to each of the plurality of statements, the comparison for selecting matching statements from the plurality of statements having the exam concept, the comparison resulting in a statement set containing the matched statements; and
generating a statement form including the statement set, the statement form for use by the user in collecting the clinically relevant information about the patient.

12) The method of claim 11, wherein the parameters of the request further include at least one medical practitioner concept for defining a characteristic of a selected medical practitioner as the user the at least one medical practitioner concept for use in comparing to the statement concepts assigned to each of the plurality of statements.

13) The method of claim 12, wherein parameters of the request further include at least one patient concept associated with the patient for defining a characteristic of the patient, the at least one patient concept for use in comparing to the statement concepts assigned to each of the plurality of statements.

14) The method of claim 13, wherein the exam type is selected from the group comprising: body part; body system; and body region.

15) The method of claim 14, wherein the exam type is further selected from the group comprising: modality type and procedure.

16) The method of claim 14, wherein the statement is selected from the group comprising: a question; answer to a question; a topic; a sentence; a phrase; a circumstance; and a menu selection.

17) The method of claim 15 further comprising the act of organizing the statement concepts by a concept hierarchy into a hierarchical order based on a plurality of concept categories.

18) The method of claim 17, wherein the concept categories are selected from the group comprising: body part; body system; and body region.

19) The method of claim 18, wherein the concept categories are further selected from the group comprising; exam modality including exam type; procedure type; procedure modifiers; specialty definition of the medical practitioner; patient sex; patient age; user type; and patient health factors.

20) The method of claim 18, wherein at least one of the body part, the body region, and the body system concept categories is the highest concept category in the hierarchical order of the concept hierarchy.

21) The method of claim 13, wherein the act of assigning associates one of the statement descriptors to two or more of the plurality of statements defined as a statement group.

22) The method of claim 21 further comprising the act of amending the statement set by an operation selected from the group comprising: removing at least one of the statements from the statement set; and adding at least one statement from the plurality of statements to the statement set.

23) A computer program product for configuring a computer to generate statements for use by a user in collecting clinically relevant information about a patient for a selected examination type, the computer program product comprising:
a computer readable medium;
a storage module stored on the computer readable medium and including a plurality of statements having statement concepts assigned to each of the plurality of statements, the statement concepts being descriptors for defining each of the plurality of statements;
a receipt module stored on the computer readable medium and configured for receiving a request having at least one parameter including an exam concept associated with the selected exam type for defining a characteristic of the selected exam type;
a matching module coupled to the receipt module and configured for comparing the exam concept to the statement concepts assigned to each of the plurality of statements, the comparison for selecting matching statements from the plurality of statements having the exam concept, the comparison resulting in a statement set containing the matched statements; and
a generation module coupled to the matching module and configured for generating a statement form including the statement set, the statement form for use by the user in collecting the clinically relevant information about the patient.
